(19) United States
(12) Patent Application Publication
(10) Pub. No.: US 2008/0055425 A1
(43) Pub. Date: Mar. 6, 2008

(54) Measuring Device

(75) Inventors: Stein Kuiper, Eindhoven (NL); Bernardus Hendrikus Wilhelmus Hendriks, Eindhoven (NL); Adrianus Sempel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,805

(22) PCT Filed: Jun. 28, 2005
(86) PCT No.: PCT/IB05/52134

§ 371 Date: Dec. 18, 2006

(30) Foreign Application Priority Data
Jun. 30, 2004 (EP) 04103058.6

(51) Int. Cl. H04N 5/228; G02B 7/28; H04N 5/232

(52) U.S. Cl. 348/222.1; 348/345; 396/111; 348/E05.031

(57) ABSTRACT

The invention relates to a measuring device comprising an image sensor, an electrowetting lens that is arranged to focus an image on the image sensor, and a control unit. The control unit is operative to determine the distance to an object based on the state of the electrowetting lens and on focus information derived from an image signal supplied by the image sensor.

The present invention relates to means for measuring the position, velocity, and/or acceleration of objects at a distance.

In automatic focusing (AF type) cameras, the distance from the camera to an object to be photographed is generally measured in accordance with a triangularization method. In this method, a far infrared beam is projected from a light-projecting element towards the object, the reflected light from the object is received by a light-receiving element, and the distance to the object is calculated on the basis of the position on the light-receiving element of the light received from the object.

However, U.S. Pat. No. 5,231,443 describes a method based on image defocus information for determining the distance of objects from a camera system. The method uses signal-processing techniques to compare at least two different images that are captured consecutively and under different lens settings. To this end the two images are converted into one-dimensional signals by summing them along a particular direction. Fourier coefficients of the one-dimensional signal and a log-by-rho-squared transform are used to obtain a calculated table. A stored table is calculated using log-by-rho-squared transformation and the Modulation Transfer Function (MTF) of the camera system. Based on the calculated table and the stored table, the distance of the desired object is determined.

According to U.S. Pat. No. 5,231,443, the lens setting is determined by four adjustable camera parameters: position of the image detector inside the camera, focal length of the optical system in the camera, the size of the aperture of the camera, and the characteristics of a light filter in the camera. In effect, the Modulation Transfer Function and the frequency content of the image signal is used for determining whether or not the image of the object is in focus or out of focus, and the distance to the object is determined based on the lens setting when the image is actually in focus.

Ranging based on image signal processing is advantageous for many applications. However, existing products are quite complex and require interaction between a number of components. In particular, the required lens system comprises a number of movable parts for controlling the focal length and the aperture. The resulting devices are therefore typically quite expensive. Furthermore, many applications require almost instant measuring. This is particularly the case when measuring the distance to moving objects. Existing devices are not capable of meeting this requirement, especially not without excessive cost and complexity.

Hence there is a need for improved range detectors that have a low degree of complexity and that facilitate low-cost manufacturing. Furthermore, there is a need for range detectors that are quick enough to measure high-speed objects.

It is thus an object of the present invention to meet this demand. This object is achieved by a measuring device as defined in claim 1. Advantageous embodiments of the measuring device are defined by the appended sub-claims.

Recent progress by the applicant has shown that traditional lenses may be exchanged for so-called electrowetting lenses. The optical power of such a lens is adjustable by controlling the spatial interrelationship of two immiscible fluids having different indices of refraction and being contained in a chamber. Basically, the position of each fluid is determined by the combined interaction of hydrophobic/hydrophilic contact surfaces in the chamber and electrostatic forces applied across electrodes. The respective fluid is affected differently and predictably by the hydrophobic/hydrophilic and electrostatic forces, and the fluids spatial interrelationship is thereby controllable.

A typical electrowetting lens comprises a closed chamber containing the two fluids and having hydrophobic and hydrophilic inner surfaces, such that the fluids reside in a well defined spatial interrelationship and define a lens shaped meniscus. Due to the different indices of refraction, the meniscus has an optical power on light traveling across the meniscus. The advantages of electrowetting lenses include low cost fabrication, no movable parts, low power consumption and compact design.

For the purpose of the present invention, it is realized that electrowetting lenses, in combination with image analyzing methods, are well suited for use in range finders. In addition to being compact, robust, and low-cost, electrowetting lenses have very rapid response times (typically in the order of 10 ms). This is highly advantageous in distance measuring devices.

Thus, according to one aspect of the invention, a measuring device is provided that comprises an image sensor, an electrowetting lens that is arranged to focus an image on the image sensor, and a control unit. The control unit is operative to determine the distance to an object based on the state of the electrowetting lens and on focus information derived from an image signal supplied by the image sensor.

In principle, every lens state is related with a range within which objects are in focus (i.e. the depth of focus). Thus, knowing the lens state and that the image is actually in focus, the distance to the object is known to be within that range.

In case very accurate distances are required, it is desirable to reduce the range within which objects are in focus (i.e. the depth of focus of the lens system). The depth of focus is a characteristic of the lens system and may be calculated using conventional ray tracing software. One way of reducing the depth of focus is, for example, to use a wide aperture.

Furthermore, accurate measurement of the distance to a moving object (e.g. a motorbike or a marathon runner) is dependent on a very rapid measuring process. There are two critical factors for the rapidness of the measuring process: the computational capability of the control unit, and the controllability of the lens. Electrowetting lenses are thus found particularly useful in this respect.

The possibility of measuring the distance to an object is very attractive for many applications. In addition, by consecutive measuring of the distance it is even possible to determine the velocity of the object towards or away from the camera. For example, measuring the distance D₁ at time T₁ and the distance D₂ at time T₂ gives the velocity V as
V=(D₂−D₁)/(T₂−T₁) (1)

In case the object has a variable speed, accurate velocity measurements depend on a short time-interval between consecutive distance measurements (i.e. T₂−T₁ should be small). This, in turn, put particularly high requirements on the distance measuring rapidness of the device.

Furthermore, measuring the distances D₁ at time T₁, D₂ at time T₂, and D₃ at time T₃ it becomes possible to calculate the acceleration a of an object
α=−((D₂−D₁)/(T₂−T₁)−(D₃−D₂)/(T₃−T₂))/((T₃−T₁)/2) (2)

In a basic configuration, the control unit analyses the image that is at the optical axis of the lens system, i.e. the object that is at the center of the image sensor. In such case the device may be aimed at a desired object, and the measurement may be carried out on a user command once the desired object is aimed at.

However, according to one embodiment, the control unit is operative to determine an angular direction to an object that is located off the optical axis. Thereby it is possible, for example, to analyze objects at an arbitrary position in the image. This may be particularly advantageous in case the measuring device is mounted stationary and is remotely monitored (e.g. a surveillance camera). In such case the device may form part of a system that comprises a user input interface. The user input interface may, for example, be a joystick with which an operator can control a pointer on a screen to point at an object to be measured. The focus information is then determined based on that particular portion of the image.

Another alternative is to sweep the lens from one extreme state to the other extreme state, and to analyze the image at a number of intermediate states (corresponding to a number of ranges that are in focus). Thereby it is possible to identify objects in the image at different distances and angles, or, in other words, to determine the position of different object in the image.

Furthermore, from the displacement in time on the image sensor of the object together with its distance it is possible to determine velocity (and acceleration) components also in a direction perpendicular to the optical axis of the camera.

According to the present invention, information on whether a particular object is in focus or not (herein referred to as “focus information”) is derived from the image signal. This can be performed in many different ways. One approach is to analyze the frequency content of the image signal. Generally, high frequencies in the signal correspond to sharp, focused images, and predominantly low frequencies correspond to blurred images that are out of focus. The frequency content may be analyzed using Fourier Transforms.

An alternative to analyzing the frequency content is to employ edge detection of the image signal. This approach involves measuring of the contrast between neighboring pixels: the higher the contrast, the sharper the image.

The measuring device is applicable for many different applications where a robust and low-cost range finder is needed. Such applications include autopilots and safety systems in vehicles such as cars and trucks (e.g. measuring the distance to another vehicle). For example the measuring device may be used to measure distances to obstacles and/or fellow road-users, e.g. facilitating automatic maintenance of a preset clearance.

Another application area is found in automatic controlling e.g. controlling a robot arm in relation to a certain object that is measured by the measuring device.

Additional applications are found in camera arrangements. For example, in an auto-focus camera the range finder can be used for controlling the auto-focus functionality. In such applications the measuring device is preferably incorporated in the camera system, such that the same lens system and image sensor is used both as range finder and as camera for taking pictures. Hence, according to one aspect of the invention, a camera arrangement is provided that comprises a measuring device as described above and wherein the electrowetting lens and the image sensor are employed also for taking pictures. Furthermore, in such a camera arrangement, establishing the distance and controlling the focus are related issues. Therefore, the control unit should preferably be operative also as an auto-focus control unit.

However, the term “control unit” should be interpreted broadly and includes the case where all controlling is carried out in one physical unit as well as the case where the controlling is carried out in a system of interconnected units that together form the “control unit”.

Having the camera functionality and ranging capability in one single unit gives a number of advantages including low cost, robustness, and compactness. Furthermore, the control unit may be operative to print the distance, velocity and/or acceleration of an object on a picture. Thereby information regarding the distance/velocity/acceleration may be automatically stored in the same memory space as the picture itself.

The advantages above (low cost, robustness, compactness) make the camera arrangement well suited in, for example, mobile phone applications. Hence, one aspect of the invention provides a mobile phone comprising a camera arrangement as described above. Such a mobile phone will thus be able to measure the distance, velocity, and/or the acceleration of objects that are aimed at with the camera.

As indicated above, surveillance cameras is another suitable application area. Hence, one aspect of the invention provides a surveillance camera that comprises a camera arrangement as described above.

The lens arrangement of the present invention may comprise more than a single electrowetting lens, in particular it may comprise conventional static lenses and it may comprise additional electrowetting lenses depending on the application. For example, in case a camera arrangement is provided, the lens arrangement may comprise at least two electrowetting lenses that together provides for an auto-focus and zoom capability of the camera.

The invention furthermore provides a method of measuring the distance from a range detector to an object. According to this method the distance is determined based on the state of an electrowetting lens and the focal status of an image signal.

The invention will now be further described with reference to the accompanying, exemplifying drawings, on which:

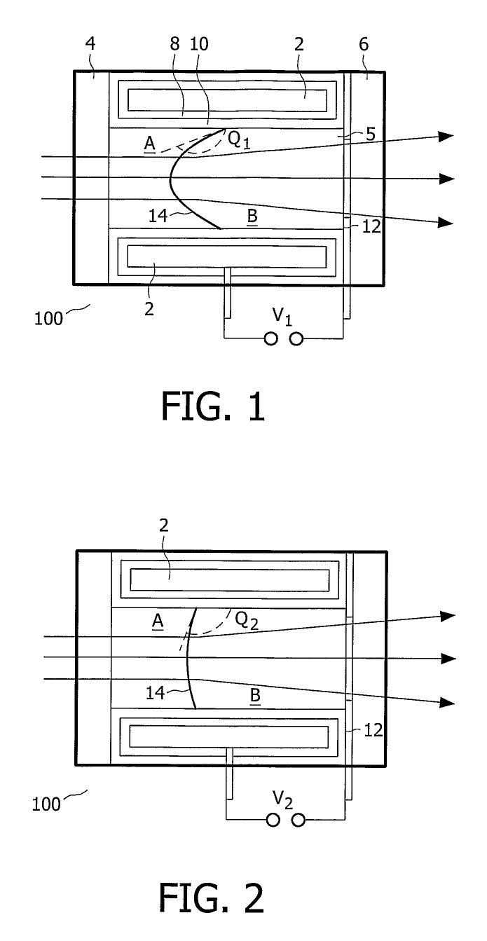

FIGS. 1-3 are schematic illustrations of an electrowetting lens in three different states.

FIG. 4 illustrates an embodiment of the range finder comprising a lens stack, an image sensor, and a control unit.

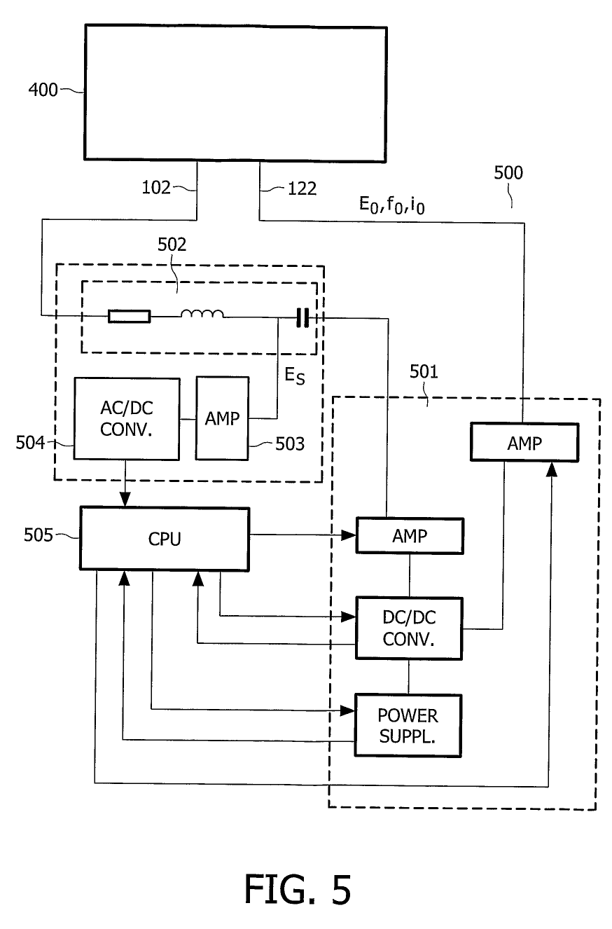

FIG. 5 illustrates an embodiment of the control unit.

The measuring device according to the present invention comprises two fundamental parts: a lens system including an image sensor, and a control unit for determining the lens state and focus information. In the following, an electrowetting lens is first described. Thereafter the operation of the control unit is described in detail. Finally, various embodiments in the form of envisaged application areas for the measuring device are described.

FIGS. 1 to 3 show a variable focus electrowetting lens 100 comprising a cylindrical first electrode 2 forming a capillary tube, sealed by means of a transparent front element 4 and a transparent back element 6 to form a fluid chamber 5 containing two fluids A and B. A second, transparent electrode 12 is arranged on the transparent back element 6 facing the fluid chamber.

The two fluids consist of two immiscible liquids in the form of an electrically insulating first liquid A, such as a silicone oil or an alkane, and an electrically conducting second liquid B, such as water containing a salt solution. The two liquids are preferably arranged to have an equal density, so that the lens functions independently of orientation of the lens, i.e. without dependence on gravitational effects between the two liquids. This may be achieved by appropriate selection of the first liquid constituents; for example, the density of alkanes or silicone oils may be modified by addition of molecular constituents to increase their density to match that of the salt solution.

Depending on the choice of the oil used, the refractive index of the oil may vary between e.g. 1.25 and 1.7. Likewise, depending on the amount of salt added, the salt solution may vary in refractive index between e.g. 1.33 and 1.50. The fluids in the particular lens described below are selected such that the first fluid A has a higher refractive index than the second fluid B. However, in other embodiments this relationship can be reversed.

The first electrode 2 may be a cylinder of inner radius typically between 1 mm and 20 mm. The electrode 2 may be formed from, for example, a metallic material and may in such case be coated by an insulating layer 8, formed for example of parylene. The insulating layer is typically between 50 nm and 100 μm, and preferably between 1 μm and 10 μm. The insulating layer is coated with a fluid contact layer 10, which reduces the hysteresis in the contact angle of the meniscus with the cylindrical wall of the fluid chamber. The fluid contact layer is preferably formed from an amorphous fluorocarbon such as Teflon™ AF1600 produced by DuPont™. The fluid contact layer 10 has a thickness of between 5 nm and 50 μm, and may be produced by successive dip coating of the electrode 2. The parylene coating may be applied using chemical vapor deposition. The wettability of the fluid contact layer by the second fluid is substantially equal on both sides if the intersection of the meniscus 14 with the fluid contact layer 10 when no voltage is applied between the first and second electrodes.

A second, annular electrode 12 is arranged at one end of the fluid chamber, in this case, adjacent the back element. The second electrode 12 is arranged with at least one part in the fluid chamber such that the electrode acts on the second fluid B.

The two fluids A and B are immiscible so as to tend to separate into two fluid bodies separated by a meniscus 14. When no voltage is applied between the first and the second electrodes, the fluid contact layer has a higher wettability with respect to the first fluid A than the second fluid B. Due to electrowetting, the wettability by the second fluid B varies under the application of a voltage between the first electrode and the second electrode, which tends to change the contact angle of the meniscus at the three phase line (the line of contact between the fluid contact layer 10 and the two liquids A and B). The shape of the meniscus is thus variable in dependence on the applied voltage.

Referring now to FIG. 1, when a low voltage V₁, e.g. between 0 V and 20 V, is applied between the electrodes the meniscus adopts a first concave meniscus shape. In this configuration, the initial contact angle θ₁ between the meniscus and the fluid contact layer 10, measured in the fluid B, is for example approximately 140°. Due to the higher refractive index of the first fluid A than the second fluid B, the lens formed by the meniscus, here called meniscus lens, has a relatively high negative power in this configuration.

To reduce the concavity of the meniscus shape, a higher magnitude of voltage is applied between the first and the second electrodes. Referring now to FIG. 2, when an intermediate voltage V₂, e.g. between 20 V and 150 V, depending on the thickness of the insulating layer, is applied between the electrodes the meniscus adopts a second concave meniscus shape having a radius of curvature increased in comparison with the meniscus in FIG. 1. In this configuration, the intermediate contact angle θ₂ between the first fluid A and the fluid contact layer 10 is for example approximately 100°. Due to the higher refractive index in the first fluid A than the second fluid B, the meniscus lens in this configuration has a relatively low negative power.

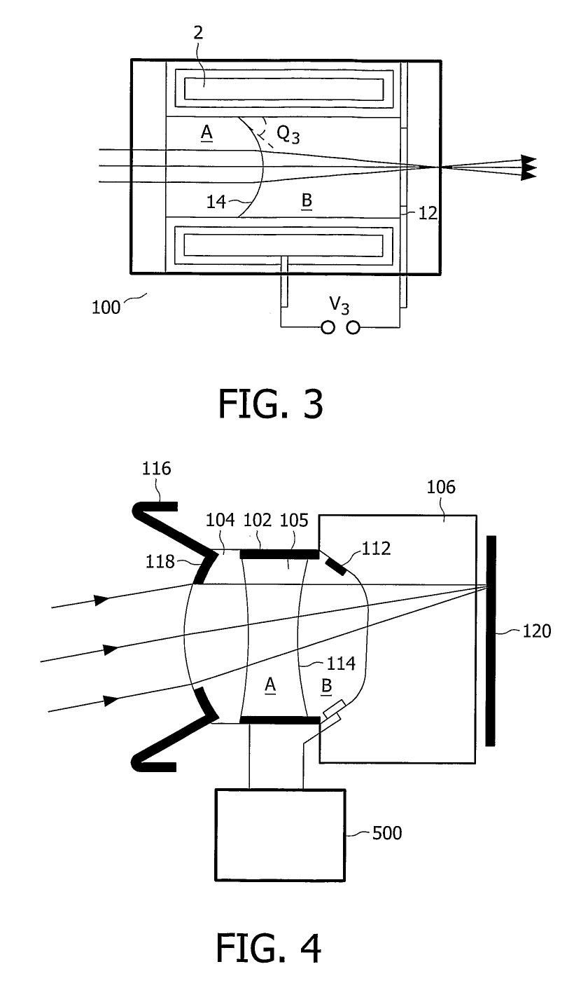

To produce a convex meniscus shape, a yet higher magnitude of voltage is applied between the first and second electrodes. Referring now to FIG. 3, when a relatively high voltage V₃, e.g. 150 V to 200 V, is applied between the electrodes the meniscus adopts a meniscus shape in which the meniscus is convex. In this configuration, the maximum contact angle θ₃ between the first fluid A and the fluid contact layer 10 is for example approximately 60°. Due to the higher refractive index of the first fluid A than the second fluid B, the meniscus lens in this configuration has a positive power.

The meniscus shape, and hence also the lens power, may easily be selected as any intermediate lens state by suitable selection of voltages applied between the two electrodes.

Although fluid A has a higher refractive index than fluid B in the above example, the fluid A may also have a lower refractive index than fluid B. For example, the fluid A may be a (per)fluorinated oil, which has a lower refractive index than water. In this case the amorphous fluoropolymer layer is preferably not used, because it might dissolve fluorinated oils. An alternative fluid contact layer is e.g. a paraffin film.

FIG. 4 illustrates a range finder including a lens stack 102-118, an image sensor 120, and a control unit 500 in accordance with an embodiment of the present invention. Elements similar to that described in relation to FIGS. 1 to 3 are provided with the same reference numerals, incremented by 100, and the previous description of these similar elements should be taken to apply here.

The device includes a compound variable focus lens including a cylindrical first electrode 102, a rigid front lens 104, and a rigid rear lens 106. The space enclosed by the two lenses and the first electrode forms a cylindrical fluid chamber 105. The fluid chamber holds the first and the second fluids A and B. The two fluids touch along a meniscus 114. The meniscus forms a meniscus lens of variable power, as previously described, depending on a voltage applied between the first electrode 102 and the second electrode 112. In an alternative embodiment, the two fluids A and B have changed positions. The front lens 104 is a convex-convex lens of highly refracting plastic, such as polycarbonate or cyclic olefin copolymer (COC), and has a positive power. At least one of the surfaces of the front lens is aspherical, to provide desired initial focusing characteristics. The rear lens element 106 is formed of a low dispersive plastic, such as COC and includes an aspherical lens surface that acts as a field flattener. The other surface of the rear lens element may be flat, spherical or aspherical. The second electrode 112 is an annular electrode located to the periphery of the refracting surface of the rear lens element 106. Hence, this compound lens comprises two conventional static lenses and an intermediate electrowetting lens.

A glare stop 116 and a aperture stop 118 are added to the front of the lens, and a pixilated image sensor 120, such as a CMOS sensor array or a CCD sensor array, is located in a sensor plane behind the lens.

An electronic control circuit 500 drives the meniscus, in accordance with a focus control signal that is derived by focus control processing of the image signals, so as to provide an object range of between infinity and 10 cm. The control circuit controls the applied voltage between a low voltage level, at which focusing on infinity is achieved, and higher voltage levels, when closer objects are to be focused. When focusing on infinity, a concave meniscus with a contact angle of approximately 140° is produced, whilst when focusing on 10 cm, a concave meniscus with a contact angle of approximately 100° is produced.

Accurate readings from the range finder depend on accurate focus information and on accurate lens state information. Accurate lens state information, i.e. information on the state of the electrowetting lens, combined with information from e.g. a look-up-table concerning the range wherein objects appear sharp on the image sensor for that particular lens state, gives a measure of the distance to an object that is sharply focused on the image sensor. The look-up-table may be formed once and for all, based on ray tracing calculations on the lens system. However, the lens state must be determined continuously. A straightforward way of measuring the lens state is to measure the voltage that is applied to the electrowetting lens. The higher the voltage, the more the lens is altered from its initial ground state. The electrowetting lens may be driven by a direct voltage (DC) or an alternating voltage (AC). Continuous operation of the lens using a direct voltage will typically result in the build-up of a remnant voltage in the lens that will deteriorate the initial relation between applied voltage and lens state. This remnant voltage effect may be alleviated to some extent using an alternating drive voltage. However, regardless of the voltage used, there will be a build-up of remnant voltage that deteriorates the relation between applied voltage and resulting lens state.

Another way of measuring the lens state is to interpret the electrowetting lens as a capacitor. Basically, the conducting second fluid, the insulting layer, and the second electrode form an electrical capacitor whose capacitance depends on the position of the meniscus. The capacitance can be measured using a conventional capacitance meter, and the optical strength of the meniscus lens can be determined from the measured value of the capacitance. In other words, for each and every lens state there is a unique capacitance that corresponds to that particular lens state. Hence, measuring the capacitance of the electrowetting cells is an alternative approach for determining the lens state.

One approach for measuring the capacitance is described in US2002/0176148. In line with that description, the capacitance of the electrowetting lens may be determined using a series LC resonance circuit. With reference to FIG. 5, an alternating current drive voltage E₀ with a predetermined frequency f₀ is applied to one electrode 112 of the optical element 400 from a power supply means 501 with impedance Z₀. The resulting electric current i₀, that will flow into electrode 112 and out of electrode 102 of the optical element 400, is led into a series LC resonance circuit 162 with impedance Zₛ and gives rise to detection voltages Eₛ in the middle point of the series LC resonant circuit 162. The detection voltage Eₛ will be proportionate to the electric current i₀.

The detection voltage Eₛ is amplified by the amplifier 503 and the amplified voltage is converted into direct voltage in an AC/DC conversion means 504 before it is supplied to CPU 505.

As an alternative to the resonance circuit, a bridge in parallel used in an LCR meter and known as a capacitance detection apparatus or other alternative approaches may equally well be used.

The capacitance of the optical element varies with respect to the applied voltage. The higher the applied voltage is, the larger the capacitance becomes. When a drive voltage E₀1 is applied by the power supply means 501, the meniscus shape of the optical element 400 is deformed and its capacitance will become C1, giving rise to the detected voltage Eₛ1. Increasing the drive voltage to E₀2>E₀1 will further deform the meniscus shape of the optical element, and the capacitance of the optical element 400 will become C2 (C2>C1). The resulting detected voltage will be Eₛ2 that is larger than Eₛ1.

Based on accurate information regarding the capacitance of the lens, the lens state may be determined. This can be done, for example, using a look-up-table that tabulates a corresponding lens state for each capacitance level. Alternatively the relation between lens state (i.e. the distance to object that are in focus) and capacitance can be estimated in a predetermined model and calculated in a processor unit.

Focusing may be performed by maximizing the high-frequency components of the image either in the spatial domain or in the frequency domain. In the frequency domain the Fourier transform is commonly used as a focus criterion, while in the spatial edge-detection is typically employed. Edge detection is based on evaluating differences in contrast between neighboring pixels. Large contrast differences indicate a sharp image whereas blurred images have a low contrast difference. Edge-detection is typically performed using high-pass spatial filters that emphasize significant variations of the light intensity usually found at the boundary of objects. High-pass filters can be linear or nonlinear, and examples of nonlinear filters include: Roberts, Sobel, Prewitt, Gradient, and Differentiation filters. These filters are useful for detecting the edges and contour of the image.

In case the frequency content is analyzed using Fourier transform, the entire camera system may first be characterized by a Modulation Transfer Function (MTF) at a set of object distances U=(u₁, u₂, . . . , uₘ) and a set of discrete frequencies V=(ρ₁, ρ₂, . . . , ρₙ).

The object distances correspond to a set of related lens states where objects at the respective object distance are in focus.

The MTF is determined by a set of camera parameters and the distance U of the object that is imaged by the camera system. Depending on the lens configuration used, the set of camera parameters includes (i) the lens state (s). The lens state refers to the shape of the meniscus as defined by e.g. the drive voltage or capacitance. The camera parameters may also include (ii) the diameter (D) of the camera aperture, and/or (iii) the focal length (f) of the optical system in the camera system.

The camera system should be configurable to at least two distinct camera settings—a first camera setting corresponding to a first set of camera parameters E₁=(s₁, f₁, D₁) and a second camera setting corresponding to a second set of camera parameters E₂=(s₂, f₂, D₂). The second set of camera parameters must differ from the first set of camera parameters in at least one camera parameter value. Preferably all parameters are kept constant, except for the lens state. A change in lens state will then lead to a change in focus value obtained with the image analysis algorithm.

Basically, each set of camera parameters provides for one distance range that is in focus and one or two ranges that are out of focus (closer and/or more distant than the distance range that is in focus). Hence, in most applications it is desirable to have a larger set of camera parameters providing for more accurate distance readings. However, an increased number of discrete distance ranges increases the computational burden and hence slows down the measuring. An increased number of ranges also puts higher accuracy demands on the lens stack as well as on the control unit rendering more expensive devices.

The frequency content analysis in the frequency domain is typically performed in a number of consecutive steps. One approach using only two camera settings is described in U.S. Pat. No. 5,231,443. Firstly, as described therein, a ratio table is calculated at the set of object distances U and the set of discrete frequencies V. The entries in the ratio table are obtained by calculating the ratio of the MTF values at a first camera setting to the MTF values at a second camera setting. Thereafter, a transformation named log-by-rho-squared transformation is applied to the ratio table to obtain a stored look-up-table Tₛ. The log-by-rho-squared transformation of a value in the ratio table at any frequency rho is calculated by first taking the natural logarithm of the value and then dividing by the square of rho.

Once the stored look-up-table is in place, the camera is set to the first camera setting specified by a first set of camera parameters E₁. A first image g₁ of the object is formed on the image detector, and it is recorded in the image processor as a first digital image. The first digital image may then be summed along a particular direction to obtain a first signal that is only one-dimensional as opposed to the first digital image that is two-dimensional. However, summing of the digital image is actually optional but may reduce the effect of noise and also the number of subsequent computations significantly. Thereafter, the first signal is normalized with respect to its mean value to provide a first normalized signal, and a first set of Fourier coefficients of the first normalized signal is calculated at a set of discrete frequencies V.

Once the calculations related to the first camera setting is performed, the camera system is set to the second camera setting specified by a second set of camera parameters E₂. A second image g₂ of the object is formed on the image detector, and it is recorded in the image processor as a second digital image. In case the first digital image was summed along a particular direction, the second digital image should be summed along the same particular direction. Thereafter, the second signal is normalized with respect to its mean value to provide a second normalized signal, and a second set of Fourier coefficients of the second normalized signal is calculated at the set of discrete frequencies V.

Once the calculations related to the two camera settings are performed, the corresponding elements of the first set of Fourier coefficients and the second set of Fourier coefficients are divided to provide a set of ratio values on which the log-by-rho-squared transformation is applied to obtain a calculated table T_{c}. Here also, the log-by-rho-squared transformation of a ratio value at any frequency rho is calculated by first taking the natural logarithm of the ratio value and then dividing by the square of rho.

In a final step, the distance of the object is calculated on the basis of the calculated table T_{c} and the stored table Tₛ.

The method above is general and applicable to all types of MTFs. In particular, it is applicable to MTFs that are Gaussian functions, and it is also applicable to sinc-like MTFs that are determined according to paraxial geometric optic model of image formation. The stored table Tₛ can be represented in one of several possible forms. In particular, it can be represented by a set of three parameters corresponding to a quadratic function, or a set of two parameters corresponding to a linear function. In either of these two cases, the distance of the object is calculated by either computing the mean value of the calculated table T_{c}, or by calculating the mean-square error between the calculated table and the stored table.

The measuring device in accordance with the present invention can be used for many different applications. For example, the police to measure the velocity of vehicles can use the measuring device. To this end, the measuring device may be incorporated into an auto focus camera that determines when a vehicle is in focus and makes a photo of the vehicle including the license plate. From the lens position at the time of the photo the distance of the vehicle is determined. This procedure is repeated a short time later. From the two lens positions and the corresponding vehicle distances the velocity of the vehicle is determined. If the velocity is higher than allowed, the pictures are stored in a memory together with the velocity values. The lens positions are determined by measuring the lens capacitance and a look-up table determines the corresponding distance.

In an alternative embodiment, the measuring device is included in a mobile phone carrying a camera module. Thereby the mobile phone is given the ability of measuring distances, velocities, and possibly also accelerations of objects at a distance from the mobile phone. The information may be displayed on a screen of the mobile phone, and/or it may be displayed on an image taken by the camera module in parallel with the performed measurement.

In yet one embodiment, the measuring device is employed in a surveillance camera. In a surveillance camera, once an intruder is detected the measuring device may first measure the distance and approach velocity of intruders. Based on this information the device may estimate the approach time of the intruder, and in case the approach time is smaller than a certain value an automatic alarm may be set off to alert security personnel.

In yet one embodiment, the measuring device is used in a car autopilot where it may be used for measuring the velocity of the car or to measure the distance to approaching obstacles. According to a particular embodiment, the autopilot may be arranged to adopt the speed and possibly also the direction of the car in case an obstacle is within a certain range and/or approaches with a certain speed. It is also possible to arrange the autopilot to maintain a certain distance to in relation to another car in front.

In yet one embodiment, the measuring device is employed for controlling a robot arm. Basically, the measuring device may be used in a way similar to the autopilot described above for controlling the robot arm when picking up objects for example. To this end, the measuring device may determine the distance and direction between the robot arm and the object. When the robot arm approaches the object, the measuring device may give information regarding not only the distance, but also the relative movement of the object in respect of the robot arm.

1. Measuring device comprising an image sensor, an electrowetting lens that is arranged to focus an image on the image sensor, and a control unit, wherein the control unit is operative to determine the distance to an object based on the state of the electrowetting lens and on focus information derived from an image signal supplied by the image sensor.

2. Measuring device according to claim 1, wherein the control unit is operative to determine a velocity of the object based on at least two consecutive measurements of the distance to the object.

3. Measuring device according to claim 1, wherein the control unit is operative to determine an acceleration of the object based on at least three consecutive measurements of the distance to the object.

4. Measuring device according to claim 1, wherein the electrowetting lens has an optical axis and wherein the control unit is operative to determine an angular direction to an object that is located off the optical axis.

5. Measuring device according to claim 1, wherein deriving of the focus information in the control unit involves analyzing the frequency content of the image signal.

6. Measuring device according to claim 1, wherein deriving of the focus information in the control unit involves edge detection of the image signal.

7. Camera arrangement comprising a measuring device according to claim 1, wherein the electrowetting lens and the image sensor are employed also for taking pictures.

8. Camera arrangement according to claim 7, wherein the control unit is operative also as an auto-focus control unit.

9. Camera arrangement according to claim 7, wherein the control unit is operative to print at least one of the distance, the velocity, and the acceleration of an object on a picture.

10. Mobile phone comprising a camera arrangement according to claim 7.

11. Surveillance camera comprising camera arrangement according to claim 7.

12. Automatic control system for controlling a movable robot arm, comprising a measuring device according to claim 1.

13. Vehicle control device, comprising a measuring device according to claim 1.

14. Method of measuring the distance to an object, wherein the distance is measured based on the state of an electrowetting lens and the focal status of an image signal.
